(19) United States
(12) Patent Application Publication
(10) Pub. No.: US 2004/0044574 A1
(43) Pub. Date: Mar. 4, 2004

(54) Apparatus for displaying local advertising to a display screen

(75) Inventors: Don W. Cochran, Novelty, OH (US); David W. Cochran, Novelty, OH (US)

Correspondence Address: Daniel A. Thomson,, Brouse McDowell, 500 First National Tower, 106 S. Main Street, Akron, OH, 44308-1471, US

(73) Assignee: Kordex, Inc., Novelty, OH

(21) Appl. No.: 10/454,032

(22) Filed: Jun. 4, 2003

Related U.S. Application Data
(60) Provisional application No. 60/385,525, filed on Jun. 4, 2002.

(51) Int. Cl. G06F 17/60

(52) U.S. Cl. 705/14

(57) ABSTRACT

An intelligent display device includes a display screen controlled by a microprocessor unit. The intelligent display device has sensors that feedback information from the environment to the microprocessor control for use in intelligently dynamically display advertisements. The display includes a connection to a network, which may be the Internet and further includes soft-keys for allowing passers-by to interact with the device.

### 1. BACKGROUND OF THE INVENTION

This application claims priority to provisional application Serial No. 60/385,525, entitled METHOD AND APPARATUS FOR EFFECTING TRANSMISSION OF LOCAL ADVERTISING MESSAGES TO LCD SCREEN VIA CELLULAR PHONE TOWERS, filed Jun. 4, 2002. This invention pertains to the art of electronic advertising and more specifically to intelligent advertising that is environmentally responsive.

A. Field of Invention

It is well known in the art to advertise on billboards for passers-by to view and read the display in hope of promoting an advertisers product or service. Certain billboards may be positioned close to a highway where drivers can read the advertising information as they travel back and forth. Establishments may place a variety of advertising billboards or signs in key locations of population or traffic density where the signs may vary in size and configuration. Some advertising signs may even include lighted images or moving parts.

It is also known to advertise via computer generated or computer controlled display screens. A computer may store and control a series of pre-programmed ads that cycle at a predetermined rate to display ads from single or multiple entities desiring to promote the entities product or service. Some of these ads devices include arrays of individually controlled lights that are programmed to scroll a message or digital image. Other devices include CRT display screens that display one or more images in succession. These ads may include static images or changing images such as movie clips and the like.

One aspect of the aforementioned advertising devices and methods includes general advertising techniques that canvass a broad target area. Such devices and methods display ads to the general populous many of whom have no need for or interest in the advertised product or service or to whom the advertiser is not actually intending to reach. Still the advertisements are effective because is reaches enough of the targeted audience to make the ad worth the investment. Still these advertisements display a static message that is not able to adapt to varying environmental situations in which the display ad is being presented.

What is needed is an intelligent device and method for dynamically advertising products or services that change with varying characteristics such as time of day, season, environmental conditions, historical or holiday events, and the like. It would be even more advantageous to have a dynamic advertising display that could interface with the targeted audience.

B. Description of the Related Art

One invention is described in U.S. Pat. No. 5,295,064 to Malec et al. This invention relates to a shopping cart display system that is responsive to trigger signals provided by transmitters located at fixed locations within a store. Stored data is transmitted to a polling transceiver located at a point of sale register for analysis. Provision is made the customer to request and receive information, such as deli numbers.

### II. Summary of the Invention

One aspect of the subject invention includes an intelligent advertising display apparatus, comprising:

a display console selectively mounted to an associated stationary structure;

at least a first electronic display for use in displaying dynamic information, the at least a first electronic display being operatively connected to the display console, the at least a first electronic display being simultaneously viewable by a plurality people traversing the associated stationary structure;

a logic processing unit operatively communicated to the at least a first electronic display, the logic processing unit having digital memory storage and at least a first digital microprocessor unit, the logic processing unit being operatively mounted proximate to the display console;

wireless communicating means for use in receiving information from an associated remote information source, the wireless communicating means being operatively communicated to the logic processing unit;

global positioning means for use in determining the fixed position of the apparatus, the global positioning means being operatively communicated with the logic processing unit;

at least a first sensor for receiving sensory feedback operatively communicated to the logic processing unit; and,

wherein the apparatus is operable to selectively display the dynamic information responsive to sensory feedback.

Another aspect of the subject invention includes at least a second electronic display operatively communicated with the logic processing unit for use in displaying the dynamic information in conjunction with the first electronic display.

Another aspect of the subject invention includes a time keeping means for use in identifying time of day, the time keeping means being operatively communicated with the logic processing unit, and,

wherein the apparatus is selectively programmable to automatically display the dynamic information responsive to the time of the day.

Another aspect of the subject invention includes at least a first sensor includes:

at least a first environmental sensor for use in sensing weather conditions.

Another aspect of the subject invention includes at least a first sensor includes:

at least a first motion sensor for use in sensing motion proximate to the display console; and,

wherein the apparatus displays dynamic information responsive to sensory feedback from the at least a first motion sensor.

Another aspect of the subject invention includes the logic processing unit is selectively programmable to automatically display the dynamic information responsive to the global position of the apparatus.

Another aspect of the subject invention includes the dynamic information displayed is advertising information for a predetermined establishment located in proximity to the apparatus.

Another aspect of the subject invention includes the frequency with which the dynamic information is displayed is dependent upon the sensory feedback stored in the digital memory of the logic processing unit.

Another aspect of the subject invention includes the information received by the wireless communicating means is stored in the memory of the logic processing unit; and,

wherein the at least a first electronic display automatically selectively displays dynamic information responsive to the information received by the wireless communication means.

Another aspect of the subject invention includes a display system, comprising:

an electronic display mounted to a fixed structure for use in displaying one of a series of dynamic messages;

a programmable controller for use in selectively controlling the displaying of the one of a series of dynamic messages;

wireless communication means operatively communicated to the controller, the wireless communication means adapted to receive associated information;

global positioning means for use in determining the fixed position of the display system, the global positioning means being operatively communicated with the controller; and,

wherein the system is interactive for use in receiving feedback from passers-by.

Another aspect of the subject invention includes feedback means for use in receiving feedback from passers-by, the feedback means being operatively communicated to the controller.

Another aspect of the subject invention includes the feedback means being a keypad.

Another aspect of the subject invention includes the keypad having selectively programmable soft-keys.

Another aspect of the subject invention includes memory to store the feedback; and,

wherein the programmable controller selectively controls displaying the one of a series of dynamic messages responsive to the feedback.

Another aspect of the subject invention includes one of a series of dynamic messages is an advertisement for a predetermined retail establishment located in proximity to the system.

Another aspect of the subject invention includes a device where the length of time that the one of a series of dynamic messages is displayed is dependent upon the feedback stored in the memory of the controller.

Another aspect of the subject invention includes the frequency with which the one of a series of dynamic messages is displayed is dependent upon the feedback stored in the memory of the controller.

Another aspect of the subject invention includes the programmable controller which automatically selectively controls the displaying of the one of a series of dynamic messages responsive to the information received by the wireless communication means.

The subject invention includes an intelligent advertising device and method for dynamically displaying information on a mobile display screen. The device may be controlled and communicated with a microprocessor based controller that can download and upload information, i.e. data and instructions, via a wireless link. The device includes intelligent devices, which may include sensors of varying types that are communicated to the microprocessor based control for analysis by artificial intelligence (AI) software. The AI software can make advertising decisions based upon sensory feedback, by user interaction or administrative changes made to the system in real time. Consequently, the intelligent advertising device may include user input means for interacting with the end viewer.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 depicts a front perspective view of an intelligent display unit.

FIG. 2 depicts a schematic view of the intelligent display unit and remote communicating unit.

FIG. 3 depicts a block diagram of one embodiment of the subject invention.

FIG. 4 depicts a block diagram of one embodiment of the subject invention.

FIG. 5 depicts an intelligent advertising device located remotely from an advertisers establishment.

### IV. DESCRIPTION OF THE INVENTION

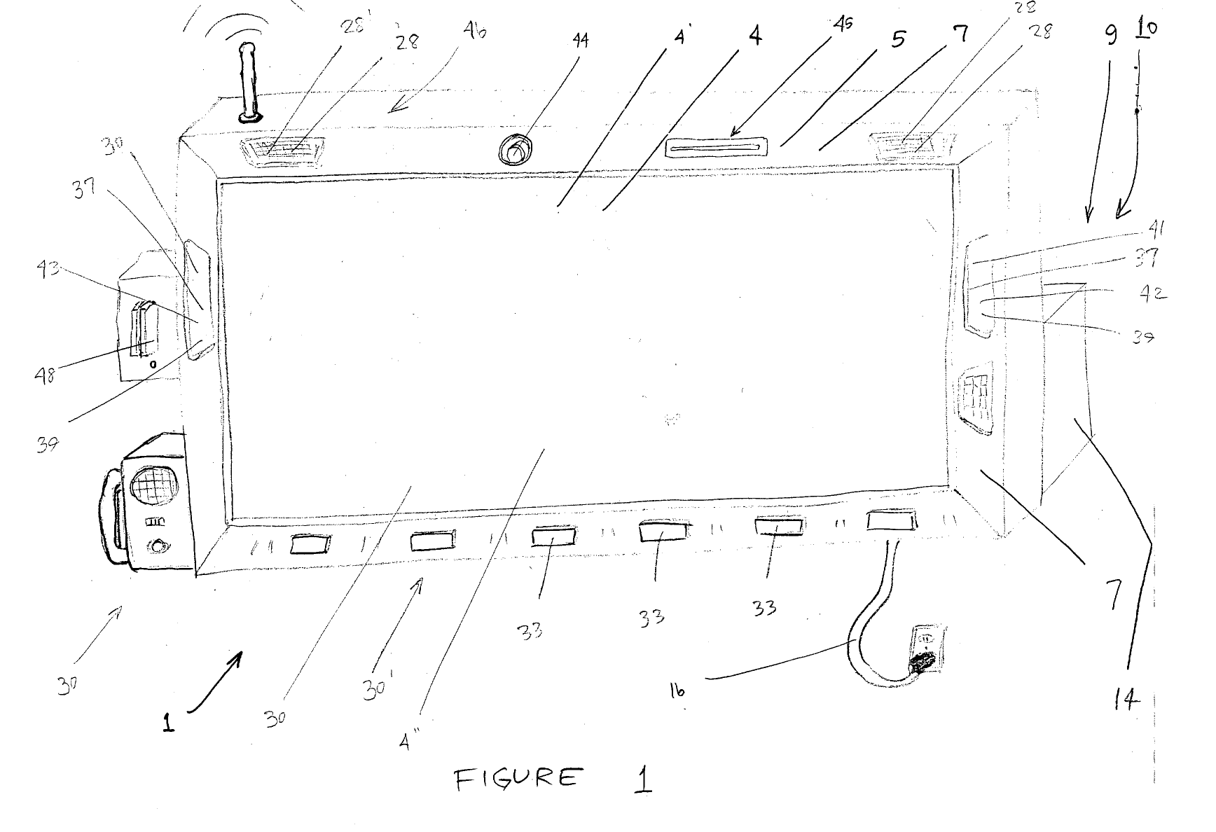

Referring now to the drawings wherein the showings are for purposes of illustrating at least one embodiment of the invention only and not for purposes of limiting the same, FIG. 1 depicts an intelligent advertising device shown generally at 1. The intelligent advertising device 1 in one embodiment is smart device that can display a variety of advertisements on displaying means 4, which may be a screen. The intelligent advertising device 1 may be able to sense surrounding conditions and alter the format or scheme by the variety of advertisements that are displayed on the displaying means 4. The intelligent advertising device 1 may also be interactive that is to say that the intelligent advertising device 1 may prompt a passer-by, which may be a viewer or user, for interacting with the intelligent advertising device 1. By interacting with the intelligent advertising device 1 it is meant that the viewer or user may respond to the intelligent advertising device 1 via input means to be discussed in a subsequent paragraph. In this way, the intelligent advertising device 1 may ask a question or provide a stimulus whereby the viewer may respond via the input means. Alternately the end user may simply interact with the device 1 without a prompting stimulus.

The intelligent advertising device 1 may be placed in a plurality of locations where passers-by would be able to easily view the dynamic advertisements being presented on the displaying means 4. Such location may include but are not limited to inside or outside the entrance of a restaurant, public restrooms, bus stops, sidewalks, professional offices, Airport concourses, Theaters, private homes, other establishments and the like. The intelligent advertising device 1 may be dynamically communicated to receive input from advertisers, which may be the owners of the establishments at which the intelligent advertising device 1 is placed in proximity to. It should be noted that placement of the intelligent advertising device 1 does not have to be right next to the associated establishment, but may be strategically placed in a region away from the establishments. The intelligent advertising device 1 may be connected remotely to a central control system, which may include wireless communication, that receives dynamic instructions changing the schema of the advertisements to be displayed. In addition, the intelligent advertising device 1 may receive interactive feedback from the viewers/users via the input means. It is to be construed that the subject invention needs not be limited to the locations as listed herein but may be applicable to any advertising situation suitable for dynamic advertisements and/or passer-by interaction.

With reference to FIG. 1, the intelligent advertising device 1 may include a display portion 4 and a housing portion 5. The housing portion 5 may be a display console 5. The housing portion 5 or display console 5 may include rigid frame members 7 to provide structural support for the display portion 4. In one embodiment, the housing portion 5 extends around the perimeter of the display portion 4, similar to the frame of a picture. It is noted that the any configuration of housing portion 5 in relation to the display portion 4 may be chosen with sound engineering judgment as is suited for use with the subject invention. The display portion 4 may be an electronic display 4′ that can dynamically display analog or digital images in a manner well known in the art. In this manner, the electronic display 4′ may be a Cathode Ray Tube or CRT device. Alternately, the display 4′ may be an LCD display device. Any manner of or device for use in displaying electronically generated information may be chosen with sound engineering without departing from the intended use of the subject invention. By electronic information it is meant that information that is generated by a transmitting device, which may be an analog signal, such as a transmitter capable of transmitting radio or other frequency waves or the like, as well as digital information, which may be generated, transferred or transmitted via microprocessor based systems in any manner chosen with sound engineering judgment. The device 1 may include mounting members, not shown. The mounting members may be hook receiving members, not shown, extended from a side of the frame members 7 or display 4. Alternately, the device 1 may include leg members, not shown, for supporting the device 1 as needed. In this way, the device 1 may be placed in or near any one of a plurality of locations, including but not limited to professional offices, walkways or sidewalks, airports, retail establishments. Any manner mounting or positioning the device 1 may be chosen with sound engineering judgment. Additionally, any size: length, height or width, may be utilized for dimensions of the intelligent advertising device 1 as chosen with sound advertising or engineering judgment.

With continued reference to FIG. 1, one embodiment of the intelligent advertising device 1 may include a control system 9. The control system 9 may be logic based or microprocessor based. That is to say the control system 9 may include a CPU, which may be a logic processor or a microprocessor. The control system 9 may include digital memory, static data storage devices including but not limited to Hard Drives, data buses and the like. In that microprocessor based systems and the supporting peripheral components and data pathways are well known in the art no further explanation will be offered at this time. The control system 9 or logic processing unit 9 may include communication means, which may be a data bus, connected from the control system 9 to the display 4 for use in transmitting or controlling information portrayed on the electronic display 4. In one embodiment, the microprocessor, not shown, may control video display memory, not shown, by loading stored digital information, which constitutes video images, into and out of memory in a manner well known in the art. However, it is to be understood that any manner of controlling the display 4 for presenting advertising images may be chosen with sound engineering judgment, including analog devices that receive and condition analog signals, which may be electromagnetic waves or other communicating means. The control system 9 may include a motherboard or other circuit board members, not shown, which comprise at least in part the control system components, shown generally at 10. The control system components 10 may reside in a housing 14 connected exterior to a side of the frame member 7. Alternately, the control system components 10 may reside within the frame members 7 and may consequently be concealed from visual detection, which may help in preventing theft and vandalism. In yet another embodiment, the control system 9 and components 10 may be remotely located with communication means providing access to and from the device 1. In other words, the control system 9 may be placed interior to the building that the device 1 is juxtaposed and may have cables or wireless communicating means operatively connecting the control system 9 to the device 1. Any position or placement of the control system 9 in relation to the display 4 may be chosen with sound engineering judgment. It should be noted that the device 1 may require standard electrical power, such as 120 VAC power readily available from a standard electrical outlet. The device 1 may include a power cord 16 that may allow power to be supplied to the device 1. The power cord 16 may be readily plugged into an available outlet or may be hard-wired into a power distribution system in any manner well known in the art. Alternately, the intelligent advertising device 1 may be powered by solar power or means. However, any means of providing power to the intelligent advertising device 1 may be chosen with sound engineering judgment.

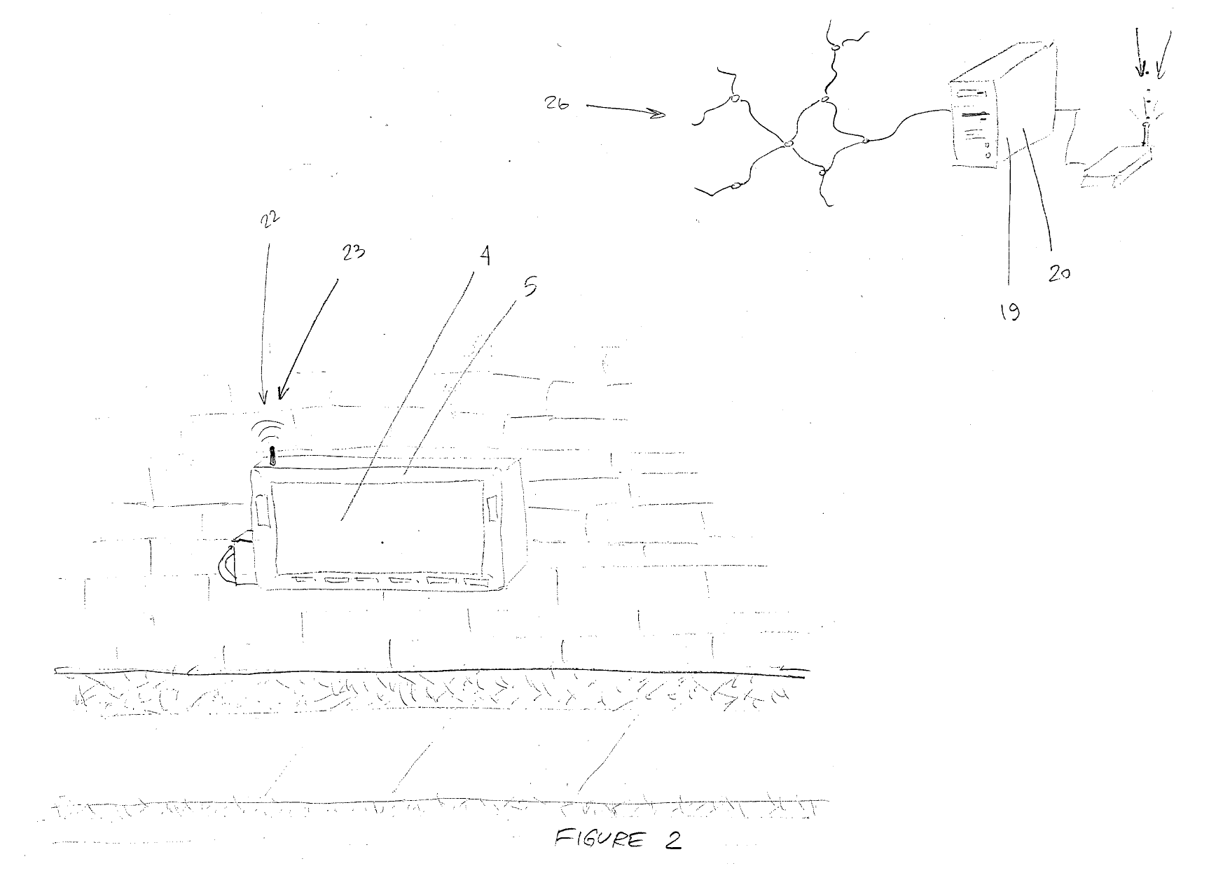

With continued reference again to FIG. 1 and also to FIG. 2, the logic processing unit 9 may be selectively programmable. By selectively programmable it is meant that varying software programs or algorithms may be selectively downloaded, created or stored in the memory of the logic processing unit 9 for execution by the microprocessor in displaying dynamic information on the electronic display 4′. The programs may include artificial intelligence algorithms to analyze information fed back from an end user through the display 4 as will be discussed in a subsequent paragraph. It is noted at this point that the logic processing unit may be wirelessly communicated to remote program downloading means 19 that may wirelessly transmit the various programs to the display 4 or to the logic processing unit 9 for use in a manner consistent with the present description. The remote program downloading program means 19 may be a microprocessor based server 20 communicated to the display 4 via wireless communication means 22, which may be cellular or any wireless communicating means, depicted generally at 23. Alternately, the display 4 and/or logic processing unit 9 may be connected through a network, which may be a local area network LAN or wide area network WAN including but not limited to the Internet 26. It should be noted at this point that the display 4 may be separate and distinct from the logic processing unit 9. In other words, the display 4 may include peripheral logic processors that assist in the display operation, which may be different from the microprocessors that execute the various programs that control the various features of displaying dynamic data on the electronic display 4. It is also noted that the governing software programs or algorithms may not be changed but may only receive instructions or commands that the programs or algorithms would use to alter the output communicated to the display 4.

With continued reference to FIGS. 1 and 2, the intelligent advertising device 1 may include additional output means for communicating dynamic information to passers-by. Output means may include sound generators 28, which may be speakers 28′. However, any type of alternate output means may be chosen and integrated in the device 1 with sound engineering judgment. Alternately, multiple display units 4 may be used in synchronization to portray an advertisement. In other words, multiple screens may be connected in an array whereby images are coordinated for display on any or all of the tiled displays 4. The intelligent advertising device 1 may further include input means 30. By input means it is meant communication channels that receive input from the surroundings of the intelligent advertising device 1. For example, the intelligent advertising device 1 may include a touch screen display 4″, which prompts a user for interaction with the intelligent advertising device 1. Softkeys 33 may also be included that allows the user to interact or provide feedback to the intelligent advertising device 1. In other words, input means 30 may be feedback means 30′. Additional input means 30 may include but are not limited to telephone access wireless or otherwise, one or more keypads, a keyboard, a credit card reading device, microphones and the like. An example of user feedback may include responding to a survey shown on the display 4 via depressing a softkey button when prompted to do so by the information presented on the display 4. In each case, the input means 30 may be connected to the logic processing unit for analyzing by the software programs to be discussed further in a subsequent paragraph. It is noted that the input means 30 may be connected to devices or even personal other than the logic processing unit 9 which will be discussed in a later paragraph. By interaction it is meant that a passer-by stops to read or hear a advertisement displayed on the intelligent advertising device 1 and that the passer-by, now user, responds to the intelligent advertising device 1 via the input means 30. The response may take any form consistent with the description of the subject invention as contained herein. For example, the user may respond to a survey by touching the answer on the touch screen or typing in an answer on a keyboard or keypad. Alternately, the user may depress a softkey programmed to print out a coupon on the printer 45 resulting from an advertisement. The credit card apparatus 48 may also be utilized by the user to purchase an item at the intelligent advertising device 1 from having reviewed information on the display 4. It is noted that the user may have noticed an ad being displayed and engaged an input means 30 which may result in further more detailed information being displayed on the screen 4″. Alternately, the intelligent advertising device 1 may sense the user stopping to read the display 4 wherein the intelligent advertising device 1 automatically adjust the advertising schema to prompt the user to see if the use wants more information or the intelligent advertising device 1 may simply automatically just display more information. In this way, the intelligent advertising device 1 may display dynamic information or advertisements.

The intelligent advertising device 1 may also include sensory feedback means 37. An array of sensors 39 may be juxtaposed to the display 4 for use in sensing various conditions surrounding the display 4 and/or the logic processing unit 9. Sensors 39 may include but are not limited to motion detectors 41, temperature sensors 42, and sound sensors 43, cameras 44, humidity sensors, light sensors, and the like. Any type, quantity or configuration of sensors 39 may be used with the intelligent advertising device 1 as chosen with sound engineering judgment. Additionally, other types of devices may be included in the intelligent advertising device 1 that provide information about the region and/or environment of the intelligent advertising device 1 including global positioning means 46 as well as time keeping means, which may be automatically adjustable to varying time zones. The global positioning means 46 may reside within the console 5 and may not be visible from the exterior of the device 1. The global positioning means 46 may be communicated to the logic processing unit 9. In this manner, when the device 1 is placed in a predetermined area, the logic processing unit 9 may alter the output presented on the display 4 responsive to the global position as indicated by the global positioning means 46. The selective presentation of data responsive to the sensor feedback, namely the global positioning means 46 in this case, may be facilitated by the software programs being executed by the logic processing unit 9 and/or program downloading means 19. In this way, the data being presented on the display is dynamic information, which will be discussed in greater detail in the following paragraphs.

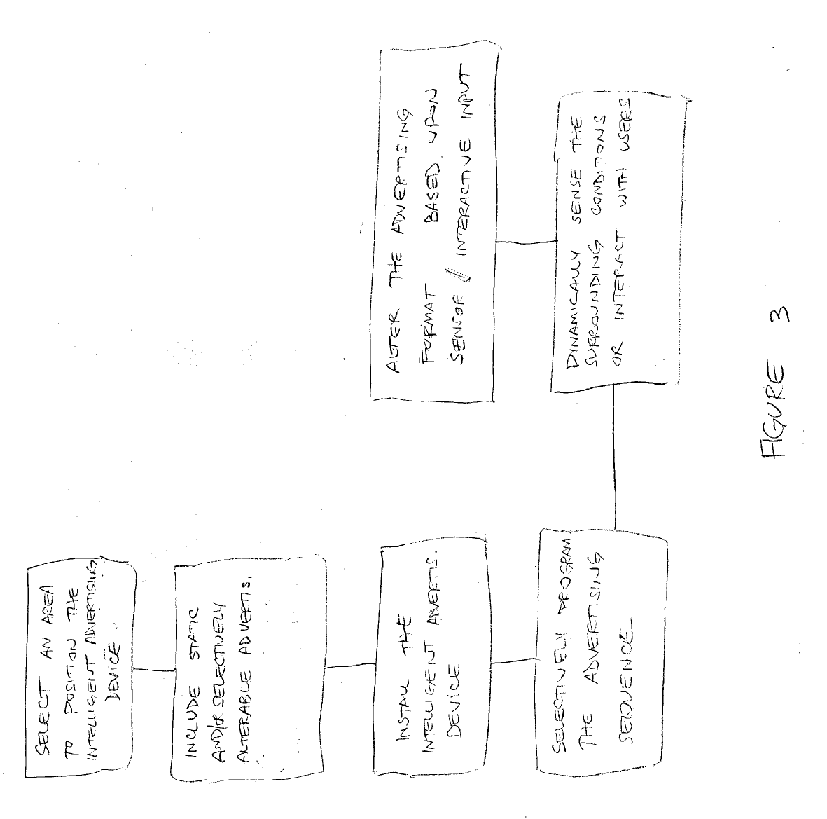

With continued reference to FIGS. 1 and 2 and now to FIG. 3, the intelligent advertising device 1 may receive a plurality of advertisements, messages or information segments that may be displayed on the electronic display 4′. The advertisements, messages or information segments may be unalterable static advertising clips, a single or a series of static images, interactive video advertisements, dynamically updated line-by-line report information, computer generated images and the like. However, any type of information and schema for displaying the information may be incorporated for use in displaying advertisements and messages on the intelligent advertising device 1 as chosen with sound engineering judgment. The advertisements may be shown on the display 4 in various manners as dictated by the input means 30 and/or selective programming of the logic processing unit 9. Such schemas may include frequency of displaying the advertisements or the message, the duration of displaying the advertisements or the message, whether the immediate advertisement is slowed down or altered, the time of day or season for displaying the advertisement or the message and the like. In fact, any manner or characteristics of displaying the advertisements or the messages on the intelligent advertising device 1 may be chosen with sound engineering and/or advertising judgment. In this way, when the intelligent advertising device 1 is selected for use at a particular location, advertisements or messages may be dynamically displayed by the intelligent advertising device 1 responsive to local conditions. The advertisements or messages may be stored or programmed for use in the intelligent advertising device 1. Subsequently, the intelligent advertising device 1 may dynamically display the advertisements or the messages responsive to the input means 30 and the selective programming of the logic processing unit to be discussed in detail below.

With continued reference to FIGS. 1 and 2, operation of the intelligent advertising device 1 will now be discussed. As previously mentioned the intelligent advertising device 1 may be controlled by a logic processing unit 9, which may include software that controls the display output from the intelligent advertising device 1. The software may include artificial intelligence and/or expert systems for use in analyzing the input data from the sensory feedback devices and generate an advertising presentation responsive to the input means 30. Additionally, the logic processing unit 9 may also contain individually designed advertisements, which may be stored in memory. The advertisements may be downloaded remotely from the downloading means 19, stored in the device 1 prior to installation or communicated to the logic processing unit 9 in any manner chosen with sound engineering judgment. In this way, the device 1 can receive new advertisements even after the device 1 has been installed for presentation in a manner consistent with the subject application. The format or schema for presenting the advertisements may also be responsive to the time keeping means, global positioning means 46 or any device communicated with the logic processing unit 9 chosen with sound engineering judgment. Additionally, the schema for displaying advertisements may be dependent upon predetermined programmed parameters such as season, date, and time or otherwise. In this way, the information being displayed by the electronic display 4′ may dynamically change with the surrounding conditions and preprogrammed parameters.

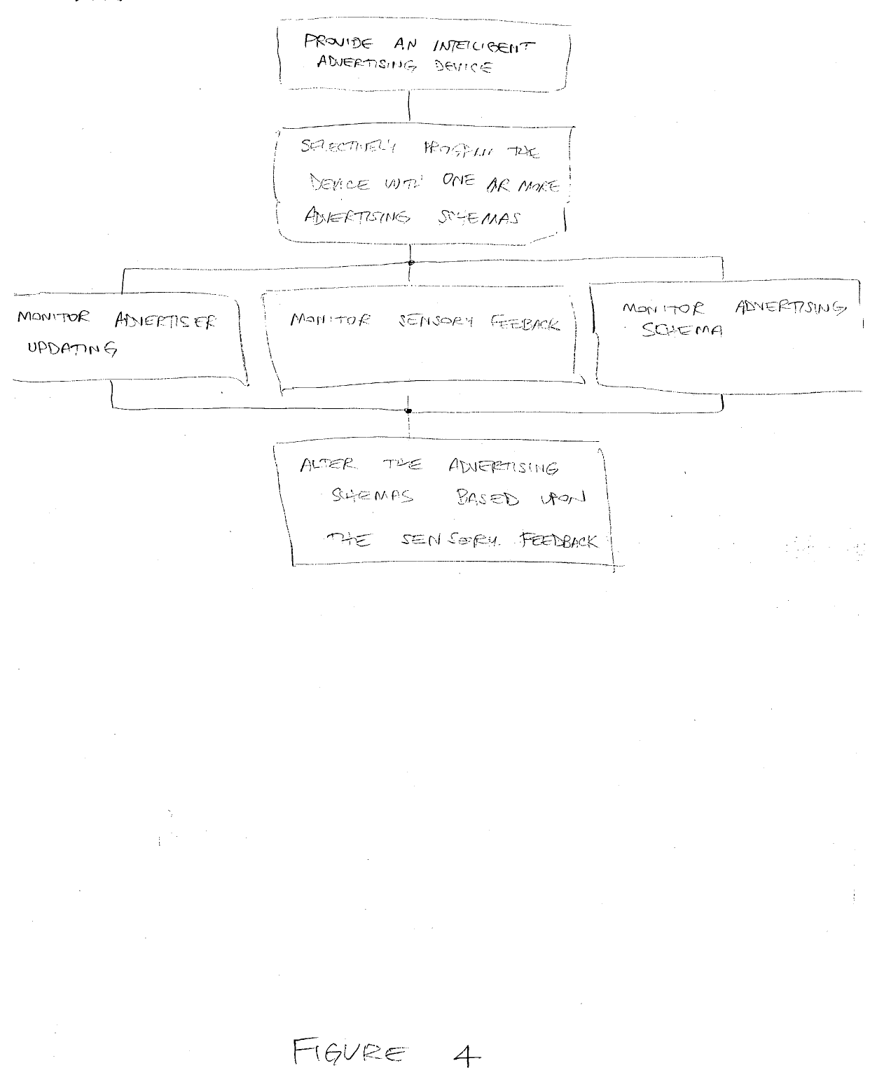

With reference to FIG. 4, the advertisements or display output of the device 1 may be selectively alterable. This is to say that the schema of the advertising information, displayed by the electronic display 4′, may be changed according to predetermined parameters as controlled by the software program. In other words, the various advertisements stored in the device 1 may be presented with different information or at different speeds based upon certain parameters. For example, the device 1 may be placed in a doctors or dentists office. One or more specific advertisements, which may be tailored to the clientele expected to be in proximity to the device 1 at the time of installation, may be stored in the device 1 for presentation on the display 4 to passers-by or in this case patients and/or vendors. The device 1 may display one of the specific advertisements with a certain base frequency, of which the base frequency may be selectively predetermined at the time of installation. The software may change the frequency of displaying the specific advertisements change responsive to the surrounding conditions as determined by the input means 30 or other predetermined parameters. More specifically, the display 4 may be showing an ad every 15 minutes in a doctor's office. However, the motion sensor may feedback information to the logic processing unit 9 indicating that the office is having increased patient activity. The logic processing unit 9 may then interpret the changes in increase motion appropriately and increase the frequency based upon the motion detected by the sensors. By interpreting changes appropriately it is meant that the artificial intelligence programming or expert system may analyze whether or not the feedback data is sustained for a certain period of time, as well as the rate of change in the feedback data, and make a decision as to what frequency the ad should be presented by the display 4. It is noted the frequency at which an ad is displayed is only one of a plurality of dynamic characteristics of which the output to the display 4 may be altered. It is to be understood that any features or characteristics of dynamically displaying information may be incorporated in the subject invention as chosen with sound engineering and advertising judgment. Another example of altering the schema of displaying the advertisements may include slowing, adding or deleting certain images from the advertisement based upon sensory feedback or other parameters. In this manner, sensory feedback indicating increased patient activity may alter the information being displayed at that particular time to include a viewer prompt to interact with the intelligent advertising device 1. The prompt may be related to a survey or a question pertinent to the type of patient expected to be in proximity of the intelligent advertising device 1. In this manner, the information being displayed on the display 4 in dynamic or responsive to the surrounding conditions.

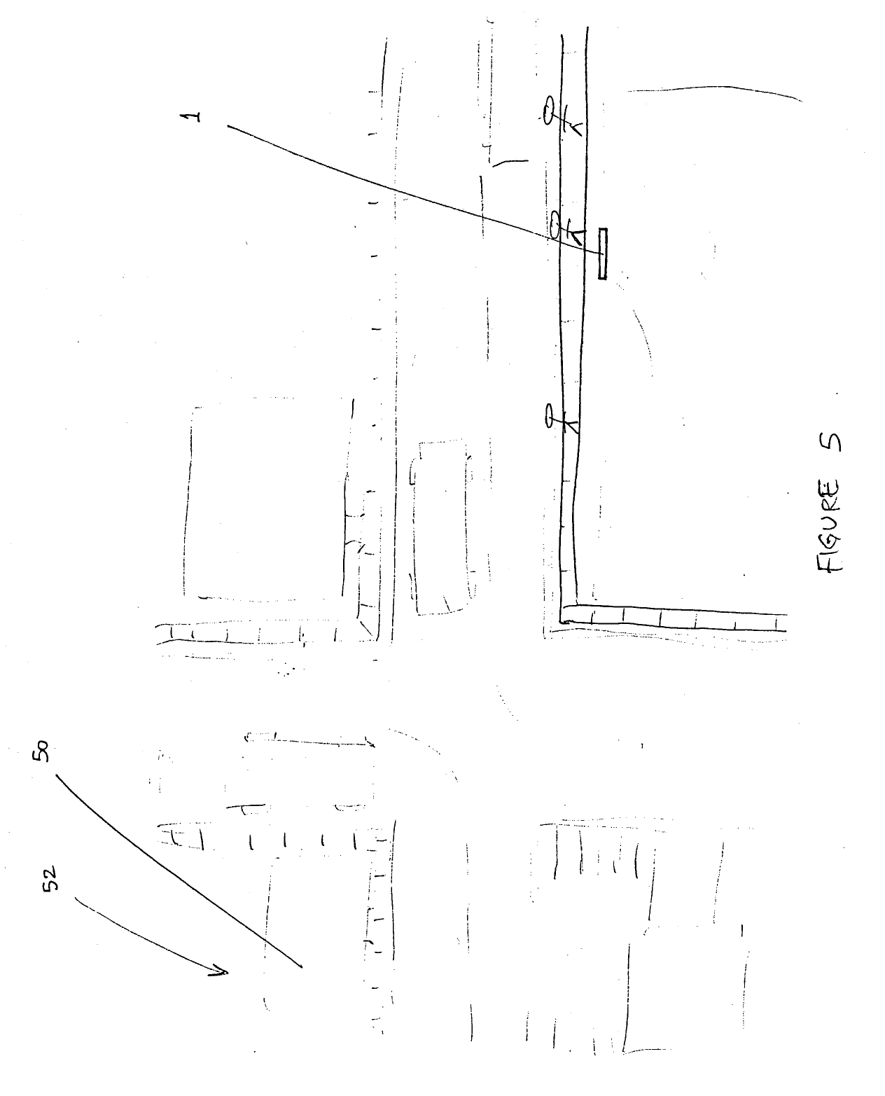

In another example, the device 1 may be placed on a sidewalk, as shown in FIG. 5. The clientele in this case may be more diverse than that of a doctor's or dentist's office. Advertisements, stored in the device 1, may be customized for surrounding establishments in proximity to the device 1, such as a restaurant 50 owned by a owner 52. Additionally, the public service information may also be available for presentation by the display 4. The device 1 may be displaying an advertisement related to the restaurant 50 when a change in feedback information about the local weather conditions is received by the logic processing unit 9. It is noted that the sensors may be supplying the feedback information in this example or alternately weather information may be downloaded from the downloading means 19. The advertisements may be interrupted responsive to the change in the local weather conditions wherein a public service announcement may be displayed on the display 4 telling passers-by where to go for safety. In this manner, the device 1 may display dynamic information. Continuing, during the normal presentation of the advertisement, which may be presented in a specific format and at a specific frequency, the information being presented on the display 4 may automatically be changed and/or increased as the time of day approaches the lunch hour. The changes in information displayed may include details about the daily specials or vacancies in the restaurant at a particular point in time. These changes may implemented via the wireless communicating means and advertiser 52 access to the downloading means 19 as discussed above. It is noted at this point that the information being displayed by the device 1 may be dynamically altered via sensory feedback, predetermined schema parameters and advertiser updating of the advertising information. It is also noted that the manner in which the advertiser may interact with device 1 may be accomplished via internet or network access through software programming or any manner chosen with sound engineering judgment. It that the selective access to a logic processing unit via a network or wireless network are well known in the art, no further explanation will be presented at this time.

With reference again to FIGS. 1 and 5, the intelligent advertising device 1 may include a camera 44 as previously mentioned. The camera 44 may be utilized to retain user interaction information and/or passer-by information. In one embodiment, the camera 44 may be constantly activated to monitor passer-by information. This type of information may be retained for analysis and communicated to the logic processing unit 9 for use in altering the advertising schema in a manner consistent with the previously description. In this way, information is obtained about passers-by not necessarily interacting with the intelligent advertising device 1. However, such information may be retained about individuals that stop to view the intelligent advertising device 1. Alternately, the camera 44 may be selectively activated to retain information about a specific user, or group of users, interacting with the intelligent advertising device 1. In other words, the camera 44 may be activated when a passer-by stops to respond to the intelligent advertising device 1. That is to say that the camera 44 may be used to retain any type of information about a person responding to the dynamic information displayed on the intelligent advertising device 1 via input means 30. In this manner, trends can be analyzed about the type of individuals, i.e. size, age, gender, socioeconomic status, etc, that respond to the prompting of the intelligent advertising device 1. For example, a local advertiser may promote a weekly special. The intelligent advertising device 1 may gather information about a specific type of individual that responds to specific advertisements. Such information may be used to alter which specials are successful and which are not.

With reference now to FIG. 5, the intelligent advertising device 1 may monitor wireless communication signatures, which may be cellular phone signatures. The logic processing unit 9 may include electronic circuitry adapted to read the signatures from passers-by whether in vehicles or otherwise. In that the use of electronic circuitry to monitor wireless communication signatures is well known in the art no further explanation will be offered at this time. In this embodiment, the intelligent advertising device 1 may gather information about the frequency at which passers-by come in proximity to the intelligent advertising device 1. Such information can be used alone or in combination with other components of the intelligent advertising device 1, e.g. feedback means, time keeping means to adjust the advertising schema and/or to retain information for advertisers. It is noted that the intelligent advertising device 1 may also communicate information wirelessly to a passer-by via the wireless communication means. In other words, a user interacting with the system may acknowledge the display 4 prompting the user for acceptance of wireless information to be communicated from the intelligent advertising device 1 to a user cell phone, personal digital assistant (PDA) or other wireless device. In this way, electronic type coupons may be downloaded to a PDA or a phone number may be automatically downloaded to a cell phone for responding to an advertiser's customer service department. However, any type of information may be communicated wirelessly to and from passers-by.

The subject invention, apparatus and method, are not to be limited by the examples described above. Rather, the examples serve as a basis for understanding the inventive method and device of dynamically advertising selective information. The situations where the device is introduced and the characteristics by which the advertising information may be dynamically altered may be changed to any advertising situation without departing from the intended purpose of the invention as described herein. It will be apparent to those skilled in the art that the above device and methods may incorporate any changes with sound engineering and advertising judgment without departing from the general scope of this invention. It is intended to include all such modifications and alterations in so far as they come within the scope of the appended claims or the equivalents thereof.

Having thus described the invention, it is now claimed:

I/we claim:

1. An intelligent advertising display apparatus, comprising:
a display console selectively mounted to an associated stationary structure;
at least a first electronic display for use in displaying dynamic information, the at least a first electronic display being operatively connected to the display console, the at least a first electronic display being simultaneously viewable by a plurality people traversing the associated stationary structure;
a logic processing unit operatively communicated to the at least a first electronic display, the logic processing unit having digital memory storage and at least a first digital microprocessing unit, the logic processing unit being operatively mounted proximate to the display console;
wireless communicating means for use in receiving information from an associated remote information source, the wireless communicating means being operatively communicated to the logic processing unit;
global positioning means for use in determining the fixed position of the apparatus, the global positioning means being operatively communicated with the logic processing unit;
at least a first sensor for receiving sensory feedback operatively communicated to the logic processing unit; and,
wherein the apparatus is operable to selectively display the dynamic information responsive to sensory feedback.

2. The apparatus of claim 1, further comprising:
at least a second electronic display operatively communicated with the logic processing unit for use in displaying the dynamic information in conjunction with the first electronic display.

3. The apparatus of claim 1, further comprising:
a time keeping means for use in identifying time of day, the time keeping means being operatively communicated with the logic processing unit, and,
wherein the apparatus is selectively programmable to automatically display the dynamic information responsive to the time of the day.

4. The apparatus of claim 1, wherein the at least a first sensor includes:
at least a first environmental sensor for use in sensing weather conditions.

5. The apparatus of claim 4, wherein the at least a first sensor includes:
at least a first motion sensor for use in sensing motion proximate to the display console; and,
wherein the apparatus displays dynamic information responsive to sensory feedback from the at least a first motion sensor.

6. The apparatus of claim 1, wherein the logic processing unit is selectively programmable to automatically display the dynamic information responsive to the global position of the apparatus.

7. The apparatus of claim 6, wherein the dynamic information displayed is advertising information for a predetermined establishment located in proximity to the apparatus.

8. The apparatus of claim 1, wherein the frequency with which the dynamic information is displayed is dependent upon the sensory feedback stored in the digital memory of the logic processing unit.

9. The apparatus of claim 1, wherein the information received by the wireless communicating means is stored in the memory of the logic processing unit; and,
wherein the at least a first electronic display automatically selectively displays dynamic information responsive to the information received by the wireless communication means.

10. An interactive advertising display system, comprising:
an electronic display mounted to a fixed structure for use in displaying one of a series of dynamic messages;
a programmable controller for use in selectively controlling the displaying of the one of a series of dynamic messages;
wireless communication means operatively communicated to the controller, the wireless communication means adapted to receive associated information;
global positioning means for use in determining the fixed position of the display system, the global positioning means being operatively communicated with the controller; and,
wherein the system is interactive for use in receiving feedback from passers-by.

11. The interactive advertising display system of claim 10, further comprising:
feedback means for use in receiving feedback from passers-by, the feedback means being operatively communicated to the controller.

12. The interactive advertising display system of claim 11, wherein the feedback means is a keypad.

13. The interactive advertising display system of claim 11, wherein the keypad has selectively programmable softkeys.

14. The interactive advertising display system of claim 11, wherein the controller includes:
memory to store the feedback; and,
wherein the programmable controller selectively controls displaying the one of a series of dynamic messages responsive to the feedback.

15. The interactive advertising display system of claim 14, wherein the one of a series of dynamic messages is an advertisement for a predetermined retail establishment located in proximity to the system.

16. The interactive advertising display system of claim 14, wherein the length of time that the one of a series of dynamic messages is displayed is dependent upon the feedback stored in the memory of the controller.

17. The interactive advertising display system of claim 14, wherein the frequency with which the one of a series of dynamic messages is displayed is dependent upon the feedback stored in the memory of the controller.

18. The interactive advertising display system of claim 10, wherein the programmable controller automatically selectively controls the displaying of the one of a series of dynamic messages responsive to the information received by the wireless communication means.

19. An intelligent advertising display apparatus, comprising:
a low-profile display enclosure selectively mounted to an associated stationary structure;
at least a first low profile, color, electronic display inside the enclosure for use in displaying dynamic information, the at least a first electronic display being operatively connected to the display console, the at least a first electronic display being simultaneously viewable through one of; an opening in the enclosure or a viewing window by a plurality of people present near the associated stationary structure;
a logic processing unit operatively communicated to the at least a first electronic display, the logic processing unit having digital memory storage and at least a first digital microprocessor unit, the logic processing unit being operatively mounted proximate to the display enclosure;
wireless communicating means for use in receiving information from an associated remote information source and for communicating back to the remote information source through the wireless communicating means, which is operatively communicated to the logic processing unit;
wherein the apparatus is operable to selectively display the dynamic information response to one of sensory feedback or viewer interaction or wireless remote input device;
at least a first sensor for receiving sensory feedback operatively communicated to the logic processing unit.

20. The apparatus of claim 19 such that the logic processing unit is located within the same outside enclosure as the display, the logic processing unit being equipped with adequate computer processing power, digital memory, and display algorithms as to function autonomously between wireless data downloads from a geographically remote central computer, to display the content in a manner unique to each such display apparatus.

21. The apparatus of claim 19 with global positioning means for determining the geographical fixed position of the apparatus, the global positioning means being operatively communicated with the logic processing unit.

22. The apparatus of claim 19, further comprising:
a time keeping means for use in identifying time of day, the time keeping means being operatively communicated with the logic processing unit, and,
wherein the apparatus is selectively programmable to automatically display the dynamic information responsive to one of the time of day, day of the week, or special calendar day.

23. The apparatus of claim 22 wherein any combination of sensory inputs is used to modify the displayed information.

24. The apparatus of claim 19, wherein the logic processing unit is selectively programmable to automatically display the dynamic information responsive to the exact geographical location of the display.

25. The apparatus of claim 24 wherein the dynamic information displayed is sponsored advertising content.

26. The apparatus of claim 25 wherein the advertising content displayed is composed of at least one of: advertising, advertorials, editorials, infomercials, entertainment, or education.

27. The apparatus of claim 26 wherein:
the advertising content is composed of a mixed combination of any of: advertising, advertorials, editorials, infomercials, entertainment, education;
the advertising content is mixed specific to one of the exact known location of the display or the demographics of the viewers.

28. The apparatus of claim 27 wherein the mix of content is modified based upon at least one intelligent software algorithm running in the logic processing unit,
the intelligent software algorithm being capable of evaluating any combination of the demographics of the viewers, sensor data, time/date data, advertiser preferences, viewer traffic, viewer preferences, and viewer feedback, to optimize for the most effective commercial use of the displayed content.

29. The apparatus of claim 25 wherein the operating system is facilitating the display of the dynamic multimedia content according to content display software algorithms
said software algorithms provide for an artificial intelligence that can evaluate any combinations of sensor, location, feedback, or instruction data and optimize the content display for best commercial result.

30. The apparatus of claim 29 wherein at least a portion of the multimedia dynamic content display consists of color video.

31. The apparatus of claim 25 wherein at least a portion of the multimedia content consists of dynamically changing “still image content”.

32. The apparatus of claim 19, further comprising:
at least a second electronic display operatively communicated with the logic processing unit for use in displaying the dynamic information in coordinated conjunction with the first electronic display.

33. The apparatus of claim 32 wherein the additional coordinated electronic displays are configured in a “tiled array” arrangement comprising a larger resultant combined display.

34. The apparatus of claim 19 wherein at least one of the frequency or length or version, or interaction choices is displayed in accordance with the recent sensory feedback stored in the digital memory which is operatively communicated with the logic processing unit.

35. The apparatus of claim 19, wherein the at least a first sensor includes:
at least a first surroundings sensor.

36. The apparatus of claim 35, wherein the at least a first sensor includes:
at least a first motion sensor for use in sensing human motion proximate to the display console;
and wherein the apparatus displays dynamic information responsive to sensory feedback from the at least a first motion sensor.

37. The apparatus of claim 35, such that one of the additional sensors is a camera.

38. The apparatus of claim 35, such that one of the additional sensors is a microphone sensitive to human voice;
the microphone being operatively connected to a logic processing unit to translate the human voice sounds by way of voice recognition software processing technology.

39. The apparatus of claim 35, such that one of the sensors is capable of receiving the digital radio signature from one of a cell phone or personal digital assistant or other personal electronic device or other personal communication device;
the digital signature of said device is stored in the memory of the logic processing unit for future use.

40. The apparatus of claim 37, such that at least one of: camera image, voice signature, fingerprint, cell-phone (wireless phone) signature, personal digital device signature, electronic watch signature such that is stored;
the stored signatures are used for commercial value.

41. The apparatus of any of claims 40 wherein the display devices are positioned in public waiting spaces to attract viewers of the displayed content.

42. The apparatus of any of claims 40 wherein the advertising display device is used in one of dentists or orthodontist waiting spaces or treatment rooms.

43. The apparatus of any of claims 19 through 40 wherein the advertising display device is used in medical professional waiting rooms or treatment rooms.

44. The apparatus of claim 35, wherein the sensors include a magnetic strip reading sensor for use with viewers' credit cards.

45. The apparatus of any of claims 43 wherein the wireless data communications is through the publicly established cellular telephone system.

46. The apparatus of any of claims 43 wherein the wireless data communications to the display units is through at least one publicly established data communications network.

47. The apparatus of claim 45, wherein the wireless data communications is in the form of digital data.

48. The apparatus of any of claims 47 wherein the wireless communications is used to download from a main server at least one of display content, display algorithms, display schedules, viewer interaction assignments, dynamic image progressions, digital video segments, timely announcements, news content.

49. The apparatus of any of claims 48 wherein the wireless data communications link will facilitate two-way communications whereby at least one of viewer interaction, viewer feedback, viewer information, viewer demographics, passer-by data, passer-by demographics, purchasing instructions, purchasing information which are periodically sent to the main server for commercial use.

50. An interactive advertising display system, comprising:
an electronic display mounted to a fixed structure for use in displaying one of a series of dynamic messages;
a programmable controller for use in selectively controlling the displaying of the one of a series of dynamic messages;
digital memory sufficient for storing the display content that will be displayed until at least the next wireless download update;
wireless communication means operatively communicated to the controller, the wireless communication means adapted to receive all display content data, updates, and instructions;
wherein the system is interactive for use in receiving feedback from interested viewers.

51. The apparatus of claim 50, wherein the user interaction is facilitated by a means other than an alpha-numeric keypad

52. The interactive advertising display system of claim 50, further comprising:
feedback means for use in receiving feedback about passers-by, the feedback means being operatively communicated to the controller.

53. The interactive advertising display system of claim 52, wherein the feedback means is a simplified keypad.

54. The interactive advertising display system of claim 52, wherein the keypad has selectively programmable softkeys;
such softkeys being located proximate to the display screen and the display will be programmed to indicate the current function of the key according to the currently displayed content.

55. The interactive advertising display system of claim 50, wherein the controller includes:
digital memory to store the feedback; and,
wherein the programmable controller selectively controls displaying the one of a series of dynamic messages responsive to the feedback.

56. The interactive advertising display system of claim 55, wherein the one of a series of dynamic messages is an advertisement for a predetermined retail establishment located in proximity to the system.

57. The interactive advertising display system of claim 55, wherein at least one of the length of time for displaying messages or the selection of dynamic messages displayed is dependent upon the feedback stored in the memory of the controller and under the control of the intelligent logic processing unit.

58. The interactive advertising display system of claim 55, wherein the content of a series of dynamic messages is displayed, at least partially, in accordance to the feedback stored in the memory associated with the controller.

59. The apparatus of claim 50, wherein the viewer that interacts with the display device is typically not the owner.

60. The apparatus of claim 52, whereby the interactive capability is facilitated by a touch-screen capability;
such touch screens being programmably changed according to the current content to encourage viewer feedback.

61. The apparatus of claim 50, wherein the algorithms used in the programmable controller automatically selectively control the displaying of the one of a series of dynamic messages responsive to the instruction information received through the wireless communication means.

62. The apparatus of claim 61, whereby the interactive display selections are modified according to the intelligent sensor feedback.

63. The apparatus of claim 50, wherein the information received by the wireless communicating means is stored in the memory of the logic processing unit; and,
wherein the at least a first electronic display automatically selectively displays dynamic information responsive to the information received or display algorithms sent by the wireless communications means.

64. The apparatus of claim 63, wherein the display automatically and selectively displays the dynamic information responsive to the combination of display algorithms and sensor feedback information.

65. The apparatus of claim 20, wherein the outer enclosure is in the form of an aesthetically pleasing and tamper resistant housing with a viewing window through which the display can be readily seen and such that it protects the electronic display screen and the other enclosed components from at least one of human, animal, or environmental abuse.

66. The apparatus of claim 50, wherein the logic processing unit is equipped with adequate computer processing power, digital memory, and display algorithms as to function autonomously for at least 10 hours, so the public network wireless data downloads from a geographically remote central computer can take place during the lower cost, off-peak time.

67. An intelligent advertising display apparatus, comprising:
a low-profile display enclosure selectively mounted to an associated stationary structure;
at least a first low profile, color, electronic display inside the enclosure for use in displaying dynamic information, the at least a first electronic display being operatively connected to the display console, the at least a first electronic display being simultaneously viewable through one of; an opening in the enclosure or a viewing window by a plurality of people present near the associated stationary structure;
a logic processing unit operatively communicated to the at least a first electronic display, the logic processing unit having digital memory storage and at least a first digital microprocessor unit, the logic processing unit being operatively mounted proximate to the display enclosure;
a communicating means for use in receiving digital information from an associated remote information source and for communicating back to the communicating means, being operatively communicated to the logic processing unit;
the content displayed is sponsored commercial messages composed of at least one of advertorials, editorials, infomercials, or education;
a means for viewers to provide interactive responses to aspects of the sponsored content;
wherein the apparatus is operable to selectively display the dynamic information response to at least one of sensory feedback, viewer interaction, or a wireless remote input device;
at least a first sensor for receiving surroundings feedback operatively communicated to the logic processing unit.

68. The apparatus of claim 67 wherein the interactive viewer feedback is accomplished through a means other than an alpha-numeric keyboard.

69. The apparatus of claim 67 wherein sensors are providing substantial information about a viewer such that content can be optimized from the information.
